(19) United States
(12) Patent Application Publication
(10) Pub. No.: US 2023/0137329 A1
(43) Pub. Date: May 4, 2023

(54) ATTACHMENT ORIENTATION SENSING DEVICE, ATTACHMENT ORIENTATION SENSING METHOD, AND ATTACHMENT ORIENTATION SENSING PROGRAM

(71) Applicant: OMRON CORPORATION, Kyoto-shi (JP)

(72) Inventors: Benika INOUE, Kyoto-shi (JP); Hideki CHUJO, Kyoto-shi (JP); Hiroyuki TANAKA, Kyoto-shi (JP); Mitsunori SUGIURA, Kyoto-shi (JP)

(73) Assignee: OMRON CORPORATION, Kyoto-shi (JP)

(21) Appl. No.: 17/953,403

(22) Filed: Sep. 27, 2022

(30) Foreign Application Priority Data
Oct. 29, 2021 (JP) 2021-178146

(51) Int. Cl. G01S 7/497; G01S 17/931

(52) U.S. Cl. CPC G01S 7/4972; G01S 17/931

(57) ABSTRACT

An attachment orientation sensing device 10 comprises a distance information acquisition unit 11, an angle information acquisition unit 12, and an attachment orientation sensing unit 14. The distance information acquisition unit 11 acquires information about the distance to reference points P1 and P2 on a floor surface FL according to the phase difference between the received light wave and the emitted light wave of the light emitted from the emission unit 21 included in a TOF sensor 20 with respect toward the floor surface FL. The angle information acquisition unit 12 acquires information about the angle to the reference points P1 and P2. The attachment orientation sensing unit 14 senses the attachment orientation of the TOF sensor 20 with respect to the floor surface FL on the basis of the distance information and the angle information acquired by the distance information acquisition unit 11 and the angle information acquisition unit 12.

### CROSS-REFERENCE TO RELATED APPLICATIONS

This application claims priority to Japanese Patent Application No. 2021-178146 filed on Oct. 29, 2021. The entire disclosure of Japanese Patent Application No. 2021-178146 is hereby incorporated herein by reference.

### BACKGROUND

### Technical Field

The present invention relates to an attachment orientation sensing device for sensing the attachment orientation of a distance measurement device attached to any of various devices with respect to a reference surface, and to an attachment orientation sensing method and an attachment orientation sensing program.

### Description of the Related Art

In recent years, a TOF (time-of flight) sensor, which measures the distance to a measurement object by receiving the reflection of light emitted from an LED (light emitting diode) toward the measurement object, has been used as a light source, for example.

For example, in order to correct deviation in the emission direction of a laser beam emitted by an object detection device, Patent Literature 1 discloses an object detection device, comprising: an emission means for emitting a beam; a reception means for receiving a reflected beam obtained when the beam emitted by the emission means hits an object and is reflected; a determination means for determining whether or not the object that reflected the reflected beam received by the reception means is a road surface; a measurement means for measuring the distance to a reflection position on the road surface on the basis of the reflected beam received by the receiving means; a calculation means for calculating the inclination angle of the road surface on the basis of the distance to the reflection position on the road surface measured by the measurement means; and a control means for controlling the emission angle of a beam on the basis of the inclination angle of the road surface calculated by the calculation means.

### CITATION LIST

### Patent Literature

Patent Literature 1: JP-A 2006-276023

### SUMMARY

### Problem to be Solved by the Invention

However, the above-mentioned conventional object detection device has the following problem.

The object detection device disclosed in the above publication is used as a laser radar installed in an automobile, and calculates the inclination angle of the road surface on the basis of the distance to the reflection position of the reflected beam, which is reflected when the beam emitted from the emission means hits the road surface, and adjusts the beam emission angle.

However, with this configuration, although the emission direction of the laser can be adjusted according to the deviation in the optical axis direction of the laser that has been distorted due to collision or the like, it is impossible to ascertain the attachment orientation of the laser radar.

Consequently, in order to ascertain the attachment orientation of the laser radar, a provided separately orientation sensing device such as an inclination sensor or a level ends up being necessary.

It is an object of the present invention to provide an attachment orientation sensing device, an attachment orientation sensing method, and an attachment orientation sensing program with which the attachment orientation of a distance measurement device attached to any of various devices can be sensed without the use of an attachment sensing device such as an inclination sensor or a level.

### Means for Solving Problem

The attachment orientation sensing device according to the first invention is an attachment orientation sensing device that senses the attachment orientation of a distance measurement device mounted on a specific thing, the device comprising a distance information acquisition unit, an angle information acquisition unit, and an attachment orientation sensing unit. The distance information acquisition unit acquires distance information about the distance to a reference point on a reference surface according to the phase difference between a received light wave and an emitted light wave emitted from an emission unit included in the distance measurement onto the reference surface. The angle information acquisition unit acquires angle information about the angle to the reference point. The attachment orientation sensing unit senses the attachment orientation of the distance measurement device with respect to the reference surface on the basis of the distance information and the angle information acquired by the distance information acquisition unit and the angle information acquisition unit.

Here, for example, in order to sense the attachment orientation of a distance measurement device mounted on a specific thing such as a conveyance device, a wall surface, or a ceiling surface, the distance information and the angle information measured by the distance measurement device are used to sense the attachment orientation of the distance measurement device with respect to the reference surface.

Here, the distance measurement device is, for example, a TOF (time-of-flight) sensor, LiDAR (light detection and ranging), an SC (structural camera), or the like that can acquire information about the distance to a reference point on a reference surface, and makes use of a sensor that obtains angle information.

Also, the “attachment orientation” of the distance measurement device means, for example, the inclination angle of the distance measurement device with respect to the reference surface, the distance from the reference surface, the rotation angle with respect to the reference surface, and so forth.

The “reference surface is,” for example, a flat surface such as a floor surface, or a wall disposed in the vertical direction, and the “reference point” on the reference surface means, for example, a specific point on a floor surface or a wall surface.

The light emitted from the emission unit includes, for example, light in the broad sense (ultraviolet light, visible light, infrared light) and the like.

The distance information acquisition unit may be configured to sense light and calculate distance information, or may be configured to acquire distance information from a distance sensor or the like provided as an external device, for example.

The attachment orientation sensing unit may be provided, for example, inside the distance measurement device, or may be provided separately from the distance measurement device.

Also, the specific thing to which the distance measurement device is mounted may be, for example, a vehicle such as a conveyance device or a passenger vehicle, or may be an indoor wall surface, a ceiling surface, an outdoor support, or the like.

Consequently, the attachment orientation of the distance measurement device with respect to a floor surface or other such reference surface can be sensed by using the results (distance information and angle information) measured or acquired by the distance measurement device.

As a result, the attachment orientation of a distance measurement device attached to any of various devices can be sensed without the use of an orientation sensing device such as an inclination sensor or a level.

The attachment orientation sensing device according to the second invention is the attachment orientation sensing device according to the first invention, wherein the attachment orientation sensing unit senses at least one of the inclination angle of the distance measurement device with respect to the reference surface, the distance from the reference surface, and the rotation angle with respect to the reference surface, as the attachment orientation.

Consequently, at least one of the inclination angle, the distance, and the rotation angle of the distance measurement device with respect to the reference surface can be sensed as the attachment orientation.

The attachment orientation sensing device according to the third invention is the attachment orientation sensing device according to the first or second invention, wherein the attachment orientation sensing unit senses the attachment orientation by using information about the distance and the angle to two reference points on the reference surface.

Consequently, the attachment orientation of the above-mentioned distance measurement device can be sensed by using information about the distance and the angle with respect to two reference points on a floor surface or other such reference surface, for example.

The attachment orientation sensing device according to the fourth invention is the attachment orientation sensing device according to any of the first to third inventions, wherein the distance measurement device further includes a distance image generation unit that generates a distance image including the reference surface, on the basis of the acquisition results of the distance information acquisition unit and the angle information acquisition unit. There is further provided a distance image acquisition unit that acquires the distance image from the distance image generation unit.

Consequently, distance information and angle information are given to each pixel included in the acquired distance image, which means that the attachment orientation of the distance measurement device can be sensed by using specific pixels as reference points.

The attachment orientation sensing device according to the fifth invention is the attachment orientation sensing device according to the fourth invention, wherein the attachment orientation sensing unit senses the attachment orientation of the distance measurement device by using a first distance to a first reference point on the reference surface at a first pixel included in the distance image acquired by the distance image acquisition unit, and a first angle with respect to the reference surface, as well as a second distance to a second reference point on the reference surface at a second pixel that is different from the first pixel, and a second angle with respect to the reference surface.

Consequently, the attachment orientation of the distance measurement device can be sensed by using the first distance to the first reference point and the first angle with respect to the reference surface, which the first pixel included in the distance image has as information, and the second distance to the second reference point and the second angle with respect to the reference surface, which the second pixel included in the distance image has as information.

The attachment orientation sensing device according to the sixth invention is the attachment orientation sensing device according to the fourth or fifth invention, wherein the attachment orientation sensing unit senses rotation with respect to the reference surface as the attachment orientation of the distance measurement device by using a first angle with respect to the emission axis of the light emitted from the emission unit at the first pixel included in the distance image acquired by the distance image acquisition unit, and a second angle with respect to the emission axis of the light emitted from the emission unit at a second pixel that is different from the first pixel.

Consequently, the attachment orientation of the distance measurement device (whether or not there is rotation with respect to the reference surface) can be sensed by using the first angle with respect to the emission axis of the light emitted from the emission unit at a first pixel included in the distance image, and the second angle with respect to the emission axis at another, second pixel.

The attachment orientation sensing device according to the seventh invention is the attachment orientation sensing device according to any of the fourth to sixth inventions, wherein the attachment orientation sensing unit senses rotation of the attachment orientation of the distance measurement device on the basis of whether or not the positions of pixels at the same distance to the reference surface in the distance image acquired by the distance image acquisition unit are moving from a specific reference position.

Consequently, rotation of the attachment orientation of the distance measurement device can be sensed according to whether or not there is movement of the positions of pixels at the same distance to the reference surface in the distance image acquired by the distance image acquisition unit.

The attachment orientation sensing device according to the eighth invention is the attachment orientation sensing device according to any of the fourth to seventh inventions, wherein the attachment orientation sensing unit senses the rotation angle of the attachment orientation of the distance measurement device on the basis of how many degrees the positions of pixels at the same distance to the reference surface in the distance image acquired by the distance image acquisition unit have rotated from a specific reference position.

Consequently, the rotation angle of the positions of pixels at the same distance to the reference surface in the distance image acquired by the distance image acquisition unit can be sensed as the rotation angle of the attachment orientation of the distance measurement device.

The attachment orientation sensing device according to the ninth invention is the attachment orientation sensing device according to any of the first to eighth inventions, further comprising a correction possibility determination unit that determines whether or not to correct the measurement result in the distance measurement device on the basis of the sensing result in the attachment orientation sensing unit.

Consequently, it can be determined whether or not to correct the distance information measured by the distance measurement device according to whether or not the attachment orientation (attachment angle, rotation angle, etc.) of the distance measurement device is within a specific permissible range.

This means that, for example, in a situation where the distance measurement device is inclined so much that the distance cannot be corrected, some other measure, such as notifying the user, can be taken without performing distance correction.

The attachment orientation sensing device according to the tenth invention is the attachment orientation sensing device according to any of the first to ninth inventions, wherein the distance information acquisition unit acquires the distance information and the angle information with respect to the reference point acquired at a specific sensing position.

Consequently, the attachment orientation can be sensed more stably and accurately by acquiring the distance information and angle information used for sensing the attachment orientation of the distance measurement device, at a specific position (specific sensing position).

The attachment orientation sensing device according to the eleventh invention is the attachment orientation sensing device according to the tenth invention, wherein the attachment orientation sensing unit senses the attachment orientation by using the distance information and the angle information with respect to the reference surface acquired at the specific sensing position.

Consequently, the attachment orientation can be sensed more stably and accurately by performing the sensing of the attachment orientation of the distance measurement device at a specific position (specific sensing position).

The attachment orientation sensing device according to the twelfth invention is the attachment orientation sensing device according to any of the first to eleventh inventions, further comprising a memory unit for storing information related to the attachment orientation of the distance measurement device sensed by the attachment orientation sensing unit.

Consequently, by storing information related to the attachment orientation of the distance measurement device, such as the mounting angle and the rotation angle, this information related to the attachment orientation can be used to correct the distance information measured by the distance measurement device.

The attachment orientation sensing device according to the thirteenth invention is the attachment orientation sensing device according to any of the first to twelfth inventions, wherein the reference surface is a floor surface.

Consequently, the attachment orientation of the above-mentioned distance measurement device can be sensed by using a floor surface as the reference surface, and setting reference points on the floor surface.

The attachment orientation sensing device according to the fourteenth invention is the attachment orientation sensing device according to any of the first to thirteenth inventions, wherein the distance measurement device is any one of a TOF (time-of-flight) sensor, a LiDAR (light detection and ranging), or an SC (structural camera).

Consequently, the attachment orientation can be sensed by using the distance information and the angle information measured by a TOF sensor, LiDAR, an SC, or any of various other distance measurement devices.

The attachment orientation sensing method according to the fifteenth invention is an attachment orientation sensing method for sensing the attachment orientation of a distance measurement device mounted on a specific thing, the method comprising a distance information acquisition step, an angle information acquisition step, an attachment orientation sensing step. The distance information acquisition step involves acquiring from the distance measurement device information about the distance to a reference point on a reference surface according to the phase difference between a received light wave and an emitted light wave of light emitted from an emission unit included in the distance measurement device toward the reference surface. The angle information acquisition step involves acquiring information about the angle to the reference point from the distance measurement device. The attachment orientation sensing step involves sensing the attachment orientation of the distance measurement device with respect to the reference surface on the basis of the distance information and the angle information acquired in the distance information acquisition step and the angle information acquisition step.

Here, for example, in order to sense the attachment orientation of the distance measurement device mounted on a specific thing such as a conveyance device, a wall surface, or a ceiling surface, the distance information and the angle information measured by the distance measurement device are used to sense the attachment orientation of the distance measurement device with respect to the reference surface.

Here, the distance measurement device is, for example, a TOF (time-of-flight) sensor, LiDAR (light detection and ranging), an SC (structural camera), or the like that can acquire information about the distance to a reference point on a reference surface, and makes use of a sensor that obtains angle information.

Also, the “attachment orientation” of the distance measurement device means, for example, the inclination angle of the distance measurement device with respect to the reference surface, the distance from the reference surface, the rotation angle with respect to the reference surface, and so forth.

The “reference surface is,” for example, a flat surface such as a floor surface, or a wall disposed in the vertical direction, and the “reference point” on the reference surface means, for example, a specific point on a floor surface or a wall surface.

The light emitted from the emission unit includes, for example, light in the broad sense (ultraviolet light, visible light, infrared light) and the like.

In the distance information acquisition step, the light may be sensed and distance information calculated, or, for example, distance information may be acquired from a distance sensor or the like provided as an external device.

The specific thing to which the distance measurement device is mounted may be, for example, a vehicle such as a conveyance device or a passenger vehicle, an indoor wall surface, a ceiling surface, an outdoor support, or the like.

Consequently, the attachment orientation of the distance measurement device with respect to a floor surface or other such reference surface can be sensed by using the results (distance information and angle information) measured by the distance measurement device.

As a result, the attachment orientation of a distance measurement device attached to any of various devices can be sensed without using an attachment sensing device such as a inclination sensor or a level.

The attachment orientation sensing program according to the sixteenth invention is an attachment orientation sensing program for sensing the attachment orientation of a distance measurement device mounted on a specific thing, the program causing a computer to execute an attachment orientation sensing method comprising a distance information acquisition step, an angle information acquisition step, and an attachment orientation sensing step. The distance information acquisition step involves acquiring from the distance measurement device information about the distance to a reference point on a reference surface according to the phase difference between a received light wave and an emitted light wave of light emitted from an emission unit included in the distance measurement device toward the reference surface. The angle information acquisition step involves acquiring information about the angle to the reference point from the distance measurement device. The attachment orientation sensing step involves sensing the attachment orientation of the distance measurement device with respect to the reference surface on the basis of the distance information and the angle information acquired in the distance information acquisition step and the angle information acquisition step.

Here, for example, in order to sense the attachment orientation of a distance measurement device mounted on a specific thing such as a conveyance device, a wall surface, or a ceiling surface, the distance information and the angle information measured by the distance measurement device are used to sense the attachment orientation of the distance measurement device with respect to the reference surface.

Here, the distance measurement device is, for example, a TOF (time-of-flight) sensor, LiDAR (light detection and ranging), an SC (structural camera), or the like that can acquire information about the distance to a reference point on a reference surface, and makes use of a sensor that obtains angle information.

Also, the “attachment orientation” of the distance measurement device means, for example, the inclination angle of the distance measurement device with respect to the reference surface, the distance from the reference surface, the rotation angle with respect to the reference surface, and so forth.

The “reference surface is,” for example, a flat surface such as a floor surface, or a wall disposed in the vertical direction, and the “reference point” on the reference surface means, for example, a specific point on a floor surface or a wall surface.

The light emitted from the emission unit includes, for example, light in the broad sense (ultraviolet light, visible light, infrared light) and the like.

In the distance information acquisition step, the light may be sensed and distance information calculated, or, for example, distance information may be acquired from a distance sensor or the like provided as an external device.

The specific thing to which the distance measurement device is mounted may be, for example, a vehicle such as a conveyance device or a passenger vehicle, an indoor wall surface, a ceiling surface, an outdoor support, or the like.

Consequently, the attachment orientation of the distance measurement device with respect to a floor surface or other such reference surface can be sensed by using the results (distance information and angle information) measured by the distance measurement device.

As a result, the attachment orientation of a distance measurement device attached to any of various devices can be sensed without using an attachment sensing device such as a inclination sensor or a level.

### (Effects)

With the attachment orientation sensing device according to the present invention, the attachment orientation of a distance measurement device attached to any of various devices can be sensed without using an attachment sensing device such as a inclination sensor or a level.

### BRIEF DESCRIPTION OF THE DRAWINGS

FIG. 1 is an oblique view of the configuration of a conveyance system in which a TOF sensor equipped with the attachment orientation sensing device according to an embodiment of the present invention is installed on a conveyance device;

FIG. 2A is a conceptual diagram showing the configuration of a conveyance system in a state in which the conveyance device of FIG. 1 has been put in a dock, and FIG. 2B is a top view of FIG. 2A;

FIG. 3 is a conceptual diagram showing the polar coordinates, Cartesian coordinates, and an orthogonal coordinate system parallel to the floor surface of the TOF sensor mounted on the conveyance device in FIG. 2A;

FIG. 4 is a control block diagram of a TOF sensor or the like included in the conveyance system of FIG. 1;

FIG. 5 is a diagram illustrating the principle that the TOF sensor in FIG. 1 calculates the distance to an object by TOF method;

FIG. 6 is a control block diagram showing the configuration of the attachment orientation sensing device included in the TOF sensor in FIG. 4;

FIG. 7 is a diagram illustrating the principle of sensing the attachment angle and the attachment height of the TOF sensor in the attachment orientation sensing device in FIG. 6;

FIG. 8 is a diagram illustrating the principle of sensing the rotation angle of the TOF sensor in the attachment orientation sensing device in FIG. 6;

FIG. 9 is a diagram illustrating the principle of sensing the rotation angle of the TOF sensor in the attachment orientation sensing device in FIG. 6;

FIG. 10A and 10B are diagrams illustrating the principle of sensing the rotation angle of the TOF sensor in the attachment orientation sensing device in FIG. 6;

FIG. 11A and 11B are diagrams illustrating the principle of sensing the attachment angle and the attachment height when the TOF sensor is rotated in the attachment orientation sensing device in FIG. 6;

FIG. 12 is a flowchart of the flow of processing to sense the attachment angle and the attachment height of the TOF sensor in the attachment orientation sensing device in FIG. 6;

FIG. 13 is a flowchart of the flow of processing to sense the rotation angle of the TOF sensor in the attachment orientation sensing device in FIG. 6;

FIG. 14 is a flowchart of the flow of processing performed when the conveyance device in FIG. 1 returns to the dock;

FIG. 15 is a diagram illustrating a state which the TOF sensor including the attachment orientation sensing device according to another embodiment of the present invention is attached to the wall of a room as a monitoring device;

FIG. 16 is a control block diagram showing the configuration of a conveyance system including the attachment orientation sensing device according to yet another embodiment of the present invention; and

FIG. 17 is a control block diagram showing the configuration of a conveyance system including the attachment orientation sensing device according to yet another embodiment of the present invention.

### DETAILED DESCRIPTION OF THE EMBODIMENT

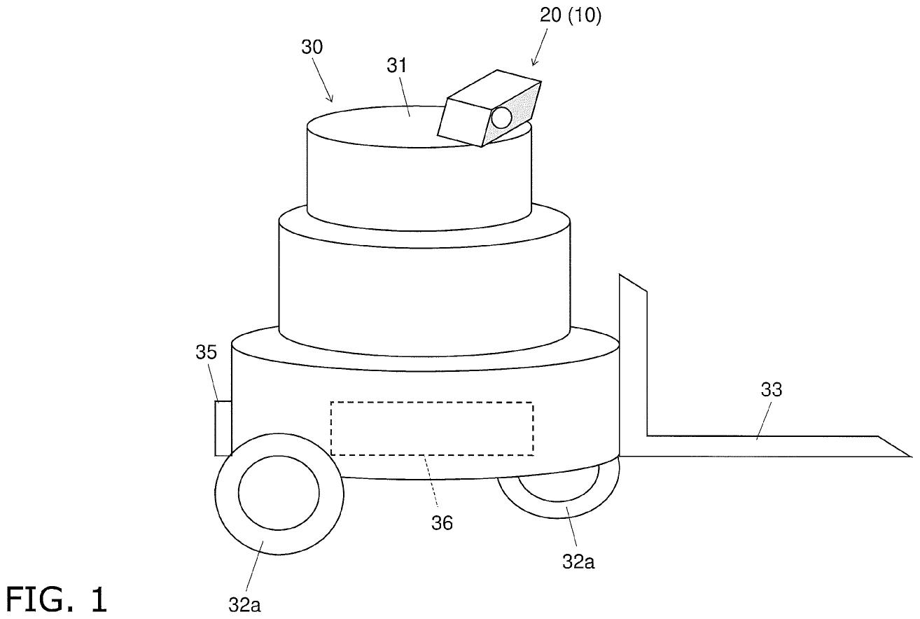

A conveyance system (distance measurement system) 50 comprising a conveyance device (specific object) 30 in which is installed a TOF sensor (distance measurement device) 20 including an attachment orientation sensing device 10 according to an embodiment of the present invention will now be described through reference to FIGS. 1 to 14.

### (1) Conveyance System 50

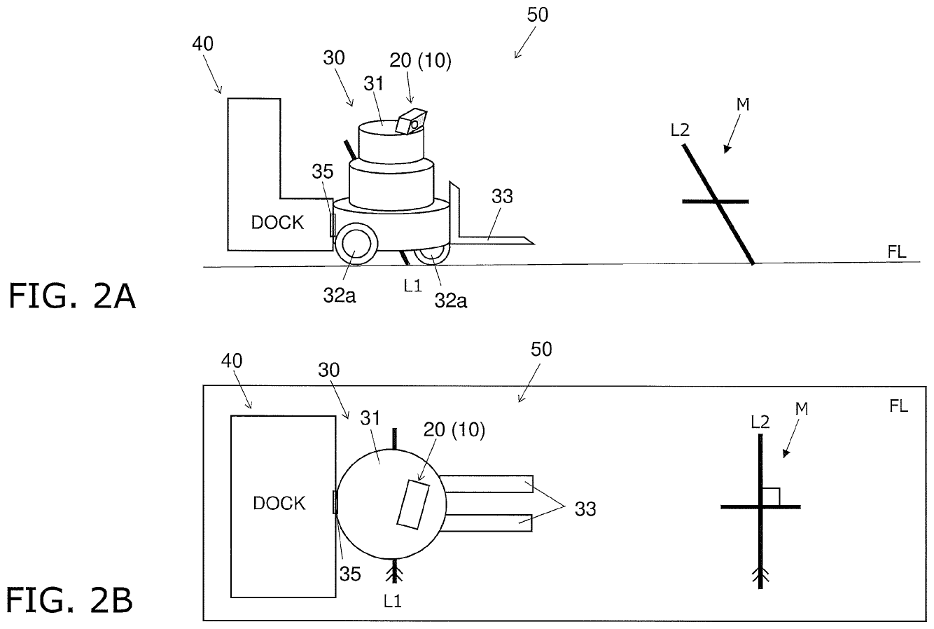

The conveyance system (distance measurement system) 50 is a system that controls such that the conveyance device 30 shown in FIG. 1 automatically carries out a desired conveyance operation, and comprises the conveyance device 30, the TOF sensor (distance measurement device) 20, the attachment orientation sensing device 10 provided in the TOF sensor 20, and a dock (specific sensing position) 40 (see FIG. 2A, etc.).

In the conveyance system 50, the conveyance device 30 automatically travels in the travel direction while obstacles and the like are recognized by the TOF sensor 20, and carries out a specific conveyance operation. Once the conveyance work is finished, or when the remaining charge of the conveyance device 30 is low, for example, as shown in FIGS. 2A and 2B, the conveyance device 30 is controlled so as to return to the dock 40 installed at a specific standby position (sensing position).

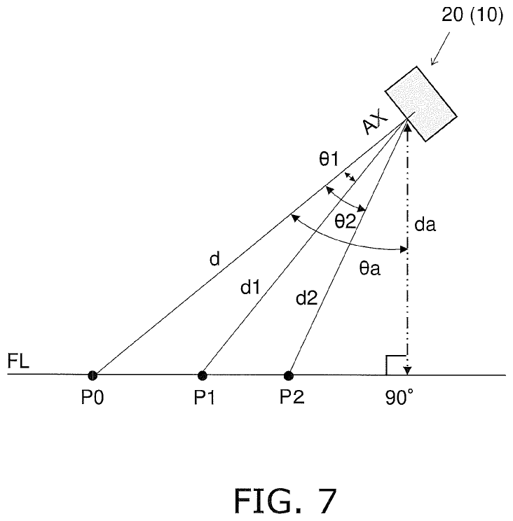

The attachment orientation sensing device 10 is provided in the interior of the TOF sensor 20, and senses the attachment orientation of the TOF sensor 20 with respect to the floor surface FL by using angle information and distance information with respect to reference points P1 and P2 (see FIG. 7, etc.) on a floor surface FL detected by the TOF sensor 20.

The detailed configuration of the attachment orientation sensing device 10 will be described in detail below.

As shown in FIG. 1, etc., the TOF sensor 20 is attached to the upper surface of the main body unit 31 of the conveyance device 30, and senses information about the distance to obstacles in the travel direction of the conveyance device 30, cargo to be conveyed, and so forth.

The detailed configuration of the TOF sensor 20 will be described in detail below.

The conveyance device (specific thing) 30 is an example of a specific thing to which the TOF sensor 20 is attached, and is, for example, an AGV (automatic guided vehicle), AMR (autonomous mobile robot), or other such automated conveyance machine that is controlled by a specific travel program. The conveyance device 30 carries out unmanned or manned conveyance work in a factory or a warehouse, for example.

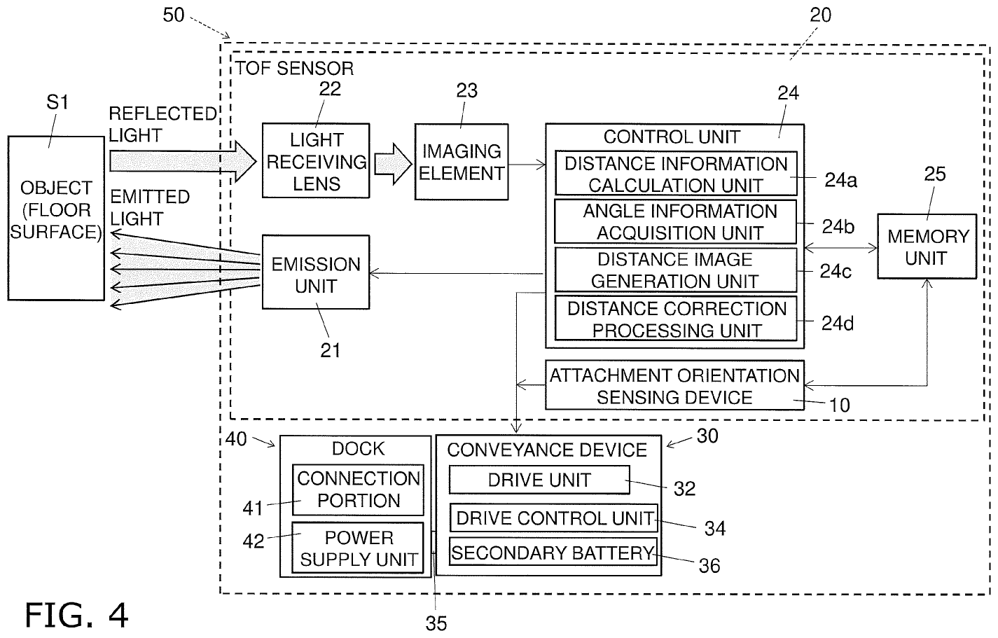

As shown in FIGS. 1, 4, etc., the conveyance device (specific thing) 30 comprises a main body unit 31, a drive unit 32, wheels 32a, forks 33, a drive control unit 34, a charging terminal 35, and a secondary battery 36.

The main body unit 31 is a substantially cylindrical housing, for example, and the TOF sensor 20 is attached to the upper surface thereof. Also, a plurality of the wheels 32a are provided, which are rotatably attached to the lower part of the main body unit 31 and allow the conveyance device 30 to move in the desired direction.

The drive unit 32 is an electric motor, for example, and the conveyance device 30 is made to travel in the desired direction by rotationally driving at least one of the wheels 32a attached to the lower part of the main body unit 31.

In this embodiment, three wheels 32a are provided to the lower part of the main body unit 31, and at least one of these is rotationally driven by the drive unit 32. Also, at least one of the wheels 32a is provided as a steerable wheel that determines the travel direction of the conveyance device 30.

The forks 33 are provided at the front of the main body unit 31, and a load is placed on these forks during conveyance work. The forks are controlled for up and down, tilt angle, and so forth by a conveyance control unit (not shown) provided to the conveyance device 30.

The drive control unit 34 controls the rotation speed and the rotation direction of the drive unit 32 that rotationally drives the plurality of wheels 32a. This allows the conveyance device 30 to move in the desired direction at the desired speed to carry out the conveyance job.

As shown in FIG. 1, the charging terminal 35 is provided on the back side (opposite side from the forks 33) of the main body unit 31. As shown in FIGS. 2A and 2B, when the conveyance device 30 is connected to the dock 40, the charging terminal 35 is connected to a connection portion 41 on the dock 40 side, and power is supplied from a charger 42 to the conveyance device 30.

As shown in FIG. 1, the secondary battery 36 is provided in the interior of the main body unit 31 of the conveyance device 30. When the conveyance device 30 is connected to the dock 40, the secondary battery 36 is repeated1y charged by the electric power supplied from the dock 40 side via the charging terminal 35. The secondary battery 36 then supplies this stored electric power to the drive unit 32.

As shown in FIGS. 2A and 2B, the dock 40 is installed at a specific standby position (sensing position) to which the conveyance device 30 returns upon finishing a conveyance job. The conveyance device 30 is connected to the dock 40 at the standby position, and the installed secondary battery 36 is charged.

Also, as shown in FIGS. 2A and 2B, a mark M made on the floor surface FL is disposed in front of the conveyance device 30 connected to the dock 40.

The mark M has a line segment L2 that is substantially parallel to the front surface of the conveyance device 30 provided with the forks 33. The line segment L2 is disposed substantially perpendicular to a straight line connecting the dock 40 and the conveyance device 30 connected to the dock 40.

Consequently, the attachment orientation sensing device 10 can sense the attachment orientation of the TOF sensor 20 mounted on the conveyance device 30 by referring to the line segment L2 of the mark M.

In this embodiment, an example is given in which the sensing of the attachment orientation of the TOF sensor 20, the determination of whether or not correction is possible, the processing to correct the measured distance information, and so forth are carried out in a state in which the conveyance device 30 is connected to the dock 40, but processing such as the sensing of the attachment orientation of the TOF sensor 20 may instead be performed in a state in which the TOF sensor 20 is not connected to the dock 40.

### (2) TOF Sensor 20

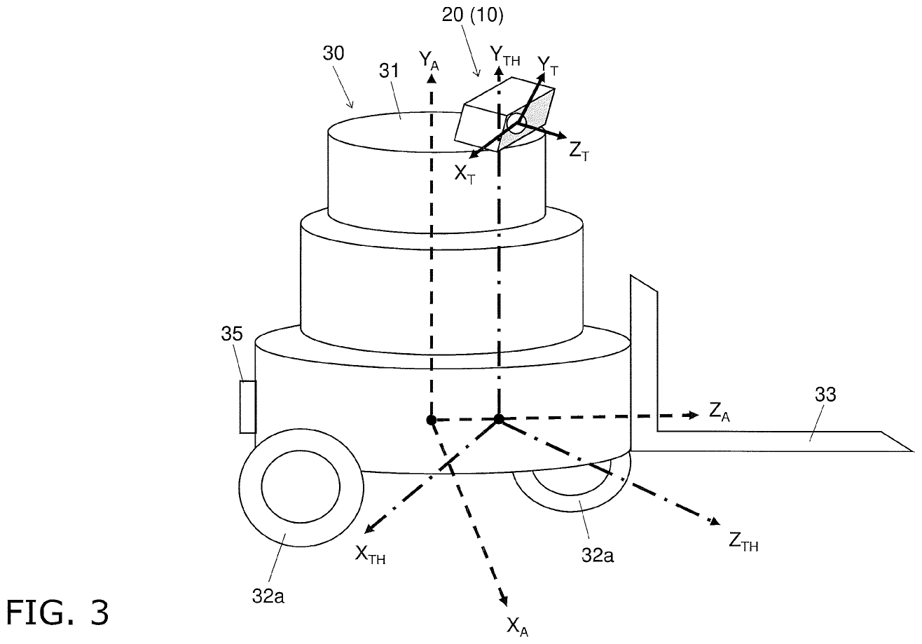

As shown in FIG. 3, the TOF sensor (distance measurement device) 20 is attached to the upper surface of the main body unit 31 of the conveyance device 30 so as to face downward from the horizontal plane. The TOF sensor 20 uses a preset angle table and a measured distance value to perform first coordinate transformation to transform a polar coordinate system into a rectangular coordinate system (the TOF optical axis coordinate system (XT, YT, ZT) indicated by the solid lines in FIG. 3). Also, the TOF sensor 20 uses the attachment angle and attachment height obtained by the sensing processing described below to perform second coordinate transformation in which the TOF optical axis coordinate system (XT, YT, ZT) is transformed into a rectangular coordinate system that is parallel to the floor surface FL (the three axes (XTH, YTH, ZTH) indicated by the one-dot chain lines in FIG. 3). Furthermore, the TOF sensor 20 uses the rotation angle of the TOF sensor 20 obtained by the rotation angle sensing processing (discussed below) to perform third coordinate transformation in which the rectangular coordinate system (XTH, YTH, ZTH) parallel to the floor surface FL is matched to the rectangular coordinate system (XA, YA, ZA) of the conveyance device 30 to which the 20 is attached.

After the third coordinate transformation is performed, the conveyance device 30 (TOF sensor 20) is disposed such that the ZA axis of the rectangular coordinate system is perpendicular to the above-mentioned line segment L2 of the mark M (see FIGS. 2A and 2B).

The “rotation angle” of the TOF sensor 20 is an angle indicating the positional deviation in the rotation direction around the emission axis of the light emitted from an emission unit 21.

As shown in FIG. 4, the TOF sensor 20 comprises the emission unit 21, a light receiving lens 22, an imaging element 23, a control unit 24, a memory unit 25, and the attachment orientation sensing device 10.

The emission unit 21 has an LED, for example, and irradiates an object such as a load or the floor surface FL with light L1 of the desired wavelength. The emission unit 21 is provided with a projection lens (not shown) that guides the light L1 emitted from the LED toward the object.

The light receiving lens 22 is provided to receive the light emitted from the emission unit 21 toward the object and reflected by the object, and guide this reflected light to the imaging element 23.

The imaging element 23 has a plurality of pixels, receives at each of the plurality of pixels the reflected light received by the light receiving lens 22, and transmits a photoelectrically converted electrical signal to the control unit 24. Also, the electrical signal corresponding to the received amount of reflected light sensed by the imaging element 23 is used by the control unit 24 to calculate distance information.

The control unit 24 reads various control programs stored in the memory unit 25 and controls the emission unit 21 that irradiates the object with light. Also, the control unit 24 adjusts the exposure time of the imaging element 23 for sensing the amount of light emitted from the emission unit 21 and the amount of reflection of the light emitted from the emission unit 21, according to the distance to the object, for example.

More specifically, the control unit 24 adjusts the exposure time to be shorter when the distance to the object is short, and adjusts the exposure time to be longer when the distance to the object is long.

As shown in FIG. 4, the control unit 24 has a distance information calculation unit 24a, an angle information acquisition unit 24b, a distance image generation unit 24c, and a distance correction processing unit 24d.

The distance information calculation unit 24a calculates information about the distance to the object for each pixel, on the basis of the electrical signal corresponding to each pixel received from the imaging element 23.

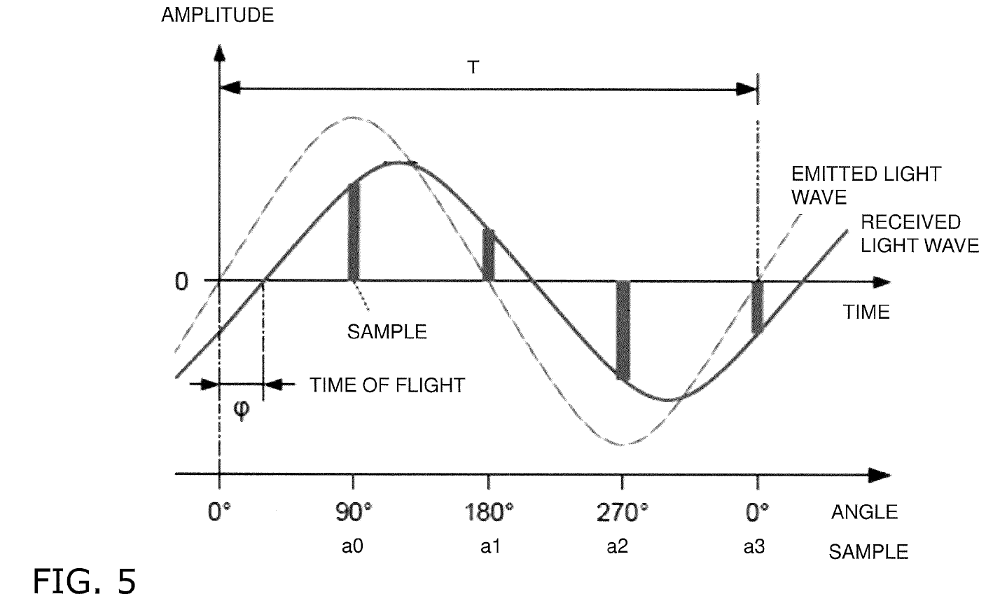

Here, the calculation of information about the distance to the object by the TOF sensor 20 in this embodiment will now be described with reference to FIG. 5.

Specifically, in this embodiment, so-called TOF (time-of-flight) method is used by the distance information calculation unit 24a to calculate the distance to the object on the basis of the phase difference Φ (see FIG. 4) between the emitted light wave with a specific AM-modulated frequency, such as a sine wave or a square wave, emitted from the emission unit 21 and the light wave received by the imaging element 23.

Here, the phase difference D is represented by the following relational expression (1).

Φ=atan(y/x) (1)

(where x=a2−a0, y=a3−a1, and a0 to a3 are amplitudes at points where the received light wave was sampled four times at 90-degree intervals)

The transformation formula from the phase difference Φ to the distance D is shown by the following relational formula (2).

D=(c/(2×fLED))×(Φ/2π)+DOFFSET (2)

(where c is the speed of light (≈3×108 m/s), fLED is the modulation frequency of the LED emitted light wave, and DOFFSET is the distance offset)

Consequently, the distance information calculation unit 24a can easily calculate the distance to the object by receiving the reflected light of the light emitted from the emission unit 21 and comparing the phase difference thereof, and using the speed of light c.

The angle information acquisition unit 24b acquires the angle (angle information) with respect to the emission axis of the light emitted from the emission unit 21 for each of the pixels constituting the imaging element 23 of the TOF sensor 20. The angle information acquisition unit 24b can also acquire angle information for each pixel stored in the memory unit 25 as a table in advance from the memory unit 25, for example.

The distance image generation unit 24c uses the distance information and the angle information calculated and acquired by the distance information calculation unit 24a and the angle information acquisition unit 24b, respectively, to generate a distance image in which the distance information and the angle information have been assigned to each pixel.

The distance correction processing unit 24d performs correction processing as necessary, on the basis of the attachment orientation (attachment angle, rotation angle, etc.) of the TOF sensor 20 sensed by the attachment orientation sensing device 10 (discussed below), for the distance information calculated by the distance information calculation unit 24a.

The memory unit 25 stores, for example, various programs for controlling the operation of the TOF sensor 20, and also stores the distance information calculated by the distance information calculation unit 24a, angle information corresponding to each pixel stored in advance as a table, the distance image generated by the distance image generation unit 24c, the distance information corrected by the distance correction processing unit 24d, and so forth.

### (3) Attachment Orientation Sensing Device 10

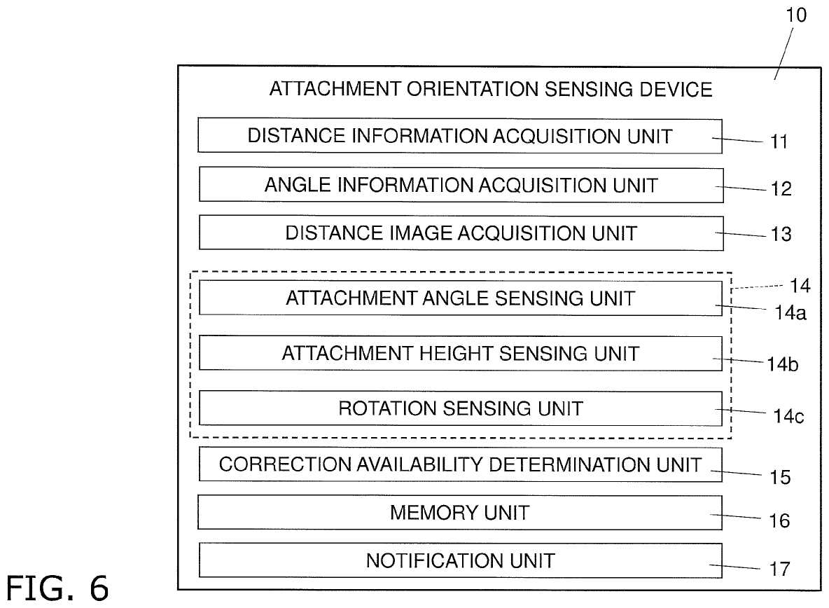

As shown in FIG. 4, the attachment orientation sensing device 10 according to this embodiment is provided inside the TOF sensor 20, and uses the angle information and the information about the distance to the reference points P1 and P2 on the floor surface FL sensed by the TOF sensor 20 to sense the attachment orientation of the TOF sensor 20 itself. As shown in FIG. 6, the attachment orientation sensing device 10 comprises a distance information acquisition unit 11, an angle information acquisition unit 12, a distance image acquisition unit 13, an attachment orientation sensing unit 14, a correction possibility determination unit 15, and a memory unit 16, and a notification unit 17.

The distance information acquisition unit 11 acquires from the control unit 24 the information about the distance to the object calculated by the distance information calculation unit 24a.

The angle information acquisition unit 12 acquires from the control unit 24 the information about the angle to the object acquired by the angle information acquisition unit 24b.

The distance image acquisition unit 13 acquires from the control unit 24 the distance image generated by the distance image generation unit 24c.

The attachment orientation sensing unit 14 uses the angle information and the information about the distance to the floor surface FL measured by the TOF sensor 20 to sense the attachment orientation of the TOF sensor 20 with respect to the floor surface FL. More specifically, as shown in FIG. 6, the attachment orientation sensing unit 14 has an attachment angle sensing unit 14a, an attachment height sensing unit 14b, and a rotation sensing unit 14c.

The attachment angle sensing unit 14a senses information related to the attachment angle of the TOF sensor 20 with respect to the floor surface FL as information related to the attachment orientation. More specifically, the attachment angle sensing unit 14a senses the attachment angle θa of the TOF sensor 20 attached to the conveyance device 30 with respect to the floor surface FL, by using angle information θ1 and θ2 corresponding to each of the pixels of the imaging element 23 and the measurement results up to the two reference points P1 and P2 (distance information d1 and d2).

The attachment height sensing unit 14b senses information related to the attachment height of the TOF sensor 20 from the floor surface FL. More specifically, the attachment height sensing unit 14b senses the attachment height da of the TOF sensor 20 attached to the conveyance device 30 with respect to the floor surface FL by using the angle information θ1 and θ2 corresponding to each of the pixels of the imaging element 23 and the measurement results up to the two reference points P1 and P2 (distance information d1, d2).

Here, the sensed attachment orientation (attachment angle θa, attachment height da) is calculated by using the results (d1, D2, θ1, θ2) of measuring the distance to any two reference points P1 and P2 on the floor surface FL, as shown in FIG. 7.

That is, if we let:

da: the attachment height of the TOF sensor from the floor surface FL (where da is a vertical line at 90° to the floor surface FL),

θa: the angle between the floor surface FL and the optical axis of the TOF sensor 20,

θ1: the angle of the first pixel of the TOF sensor 20 with respect to the center of the TOF (sensor specifications),

d1: the distance (measured value) from the first pixel of the TOF sensor 20 to the reference point P1 on the floor surface FL,

θ2: the angle of the second pixel of the TOF sensor 20 with respect to the TOF center (sensor specifications),

d2: the distance from the second pixel of the TOF sensor 20 to the reference point P2 on the floor surface FL (measured value),

then the following relational expressions are valid.

cos(θa)=da/d

cos(θa−θ1)=da/d1

cos(θa−θ2)=da/d2

Consequently, the attachment height da is expressed by the following two equations, using the attachment angle θa, the angle information (θ1, θ2), and the information about the distance (d1, d2) to the reference points P1 and P2.

da=d1cos (θa−θ1) (1)

da=d2cos (θa−θ2) (2)

Here, since θ1 and θ2 are known values determined by the sensor specifications, and d1 and d2 are values obtained by measurement, the attachment height da and the attachment angle θa can be calculated from the equations (1) and (2).

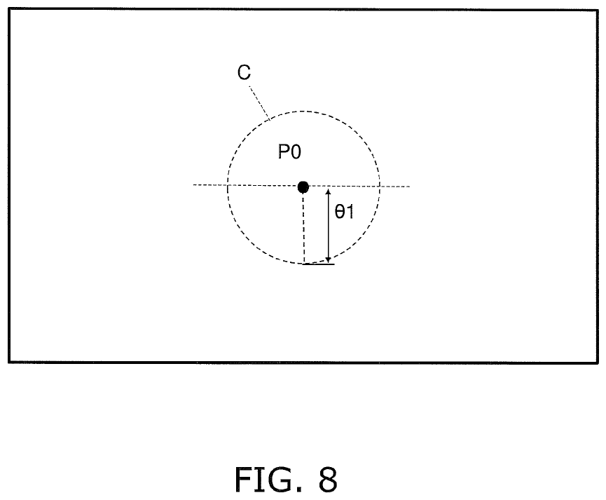

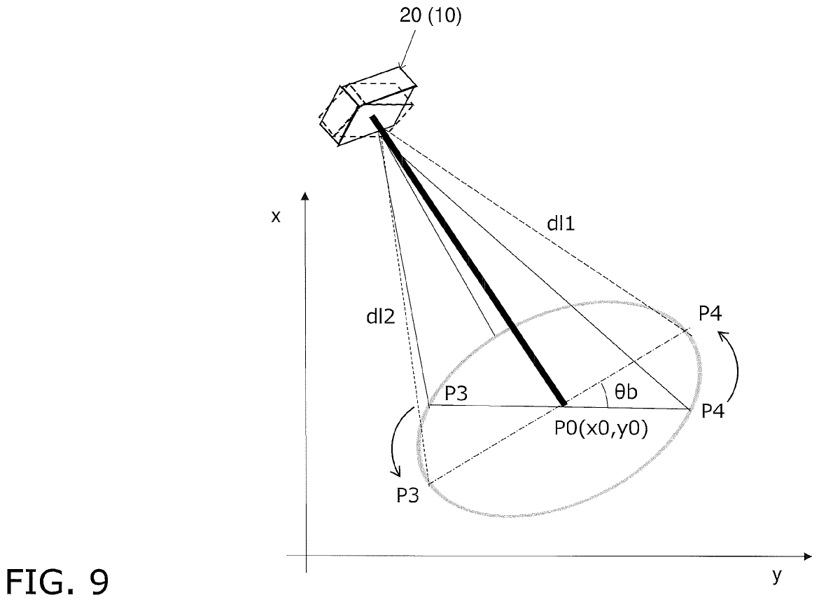

The rotation sensing unit 14c senses information related to the rotation angle around the optical axis of the TOF sensor 20. More specifically, as shown in FIG. 8, in the rotation sensing unit 14c, all of the pixels lying on a circle C centered on the center pixel P0 of the frame of the distance image generated by the distance image generation unit 24c of the TOF sensor 20 attached to the conveyance device 30 should have the same angle of view (such as θ1). Consequently, as shown in FIG. 9, the rotation sensing unit 14c calculates the rotation angle θb along with detecting whether or not there is rotation of the TOF sensor 20, according to whether or not the position of the pixels on the circle C centered on the image center of the frame image are moving.

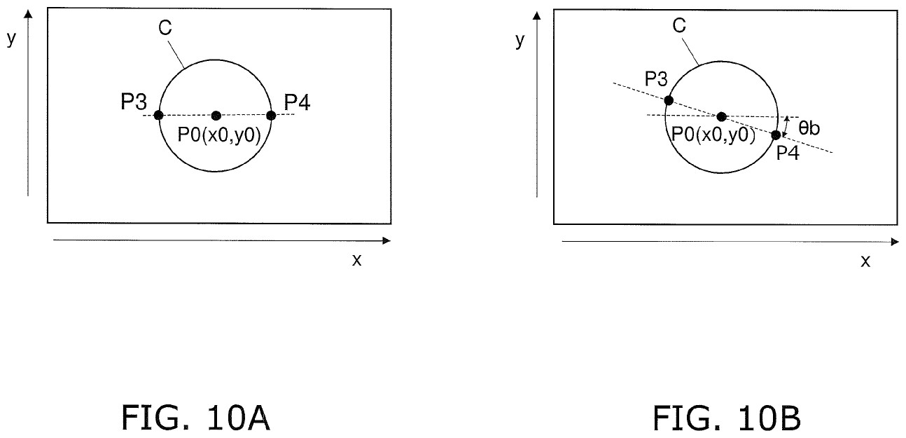

That is, as shown in FIG. 10A, with the rotation angle θb sensed by the rotation sensing unit 14c, when there is no rotation of the TOF sensor 20, the sensed distance to the pixels P3 and P4 intersecting the horizontal line passing through the center pixel P0 (x0, y0) is the same. On the other hand, when there is rotation of the TOF sensor 20, as shown in FIG. 10B, the pixels at the same sensed distance to the pixels P3 and P4 move by the amount of the rotation angle θb.

Consequently, the rotation angle θb of the TOF sensor 20 can be found from whether there is a change in the positions of the pixels P3 and P4 at the same distance, and the rotation angle thereof.

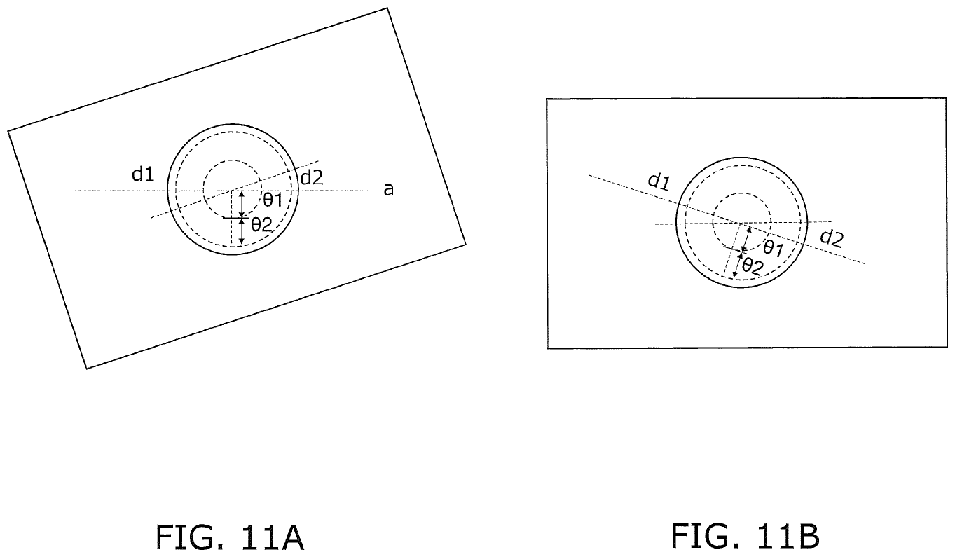

Regarding the attachment angle θa and the attachment height da when the TOF sensor 20 is rotating, as shown in FIGS. 11A and 11B, the pixels of θ1 and θ2 can be found in the same way by letting d1 and d2 be the distances of the pixels at the intersections with the vertical line passing through the center of the diameter line a connecting the above-mentioned same distances and the same angle circle.

The correction possibility determination unit 15 determines whether to correct the measurement result (distance information) in the distance information calculation unit 24a of the control unit 24 on the basis of information about the installation angle and the rotation angle sensed by the attachment angle sensing unit 14a and the rotation sensing unit 14c of the attachment orientation sensing device 10.

Here, a case in which correction is not possible is, for example, a case in which the attachment orientation of the TOF sensor 20 has been greatly distorted as a result of the conveyance device 30 colliding with an unexpected obstacle or the like while traveling.

Then, whether or not correction is possible is determined according to whether or not the attachment angle and the rotation angle sensed by the attachment angle sensing unit 14a and the rotation sensing unit 14c of the attachment orientation sensing device 10 are within the preset correctable reference range.

Consequently, when the sensing result in the attachment orientation sensing device 10 indicates a large amount of distortion of the attachment orientation of the TOF sensor 20, measures can be taken such as sending a notice prompting the user to adjust the attachment orientation of the TOF sensor 20, without correcting the distance value, which is the measurement result.

The memory unit 16 stores information about the attachment orientation (attachment angle, rotation angle, etc.) of the TOF sensor 20 sensed by the attachment orientation sensing unit 14.

Consequently, the TOF sensor 20 can use the information related to the attachment orientation of the TOF sensor 20 stored in the memory unit 16 to correct the measurement result (distance information).

For example, if the correction possibility determination unit 15 has determined that the distance information cannot be corrected, it is highly probable that the attachment orientation of the TOF sensor 20 will be extremely distorted, etc., so the notification unit 17 notifies the user to adjust the attachment orientation of the TOF sensor 20.

### Attachment Orientation Sensing Method

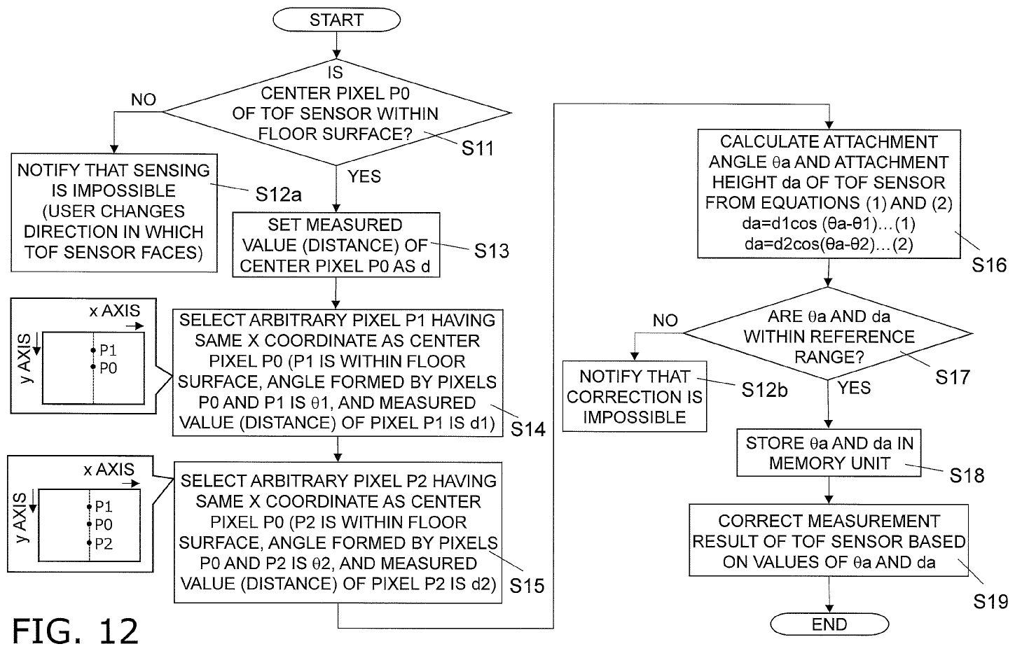

The method for sensing the attachment orientation of the TOF sensor 20 in this embodiment will now be described through reference to the flowchart shown in FIG. 12.

Here, a step of sensing the attachment angle θa and the attachment height da as the attachment orientation of the TOF sensor 20 will be described.

First, as shown in FIG. 12, in step S11 it is determined whether or not the center pixel P0 of the TOF sensor 20 is within the floor surface FL. Here, if the center pixel P0 is within the floor surface FL, the processing proceeds to step S13, and if the center pixel P0 is outside of the floor surface FL, the processing proceeds to step S12a.

Regarding the determination in step S11, it is not essential that the determination be made on the basis of the center pixel, and some pixel other than the center pixel may be used, but in this embodiment the center pixel is used in order to simplify the description.

Here, in step S12,since it was determined in step S11 that the center pixel P0 was outside of the floor surface FL, the notification unit 17 notifies the user that information related to the attachment orientation of the TOF sensor 20 cannot be sensed.

Next, in step S13, since it was determined in step S11 that the center pixel P0 was within the floor surface FL, light is emitted from the emission unit 21 and the reflected light is received by the imaging element 23, and the measured value (distance information) of the center pixel P0 of the TOF sensor 20 is set as d.

Next, in step S14, an arbitrary pixel P1 having the same x coordinate as the center pixel P0 is selected. Here, P1 is within the floor surface FL, the angle formed by the center pixel P0 and an arbitrary pixel P1 is θ1, and the measured value (distance) of the arbitrary pixel P1 is d1 (distance and angle information acquisition step).

Next, in step S15, an arbitrary pixel P2 having the same x coordinate as the center pixel P0 is selected. Here, the arbitrary pixel P2 is within the floor surface FL, the angle formed by the center pixel P0 and the arbitrary pixel P2 is θ2, and the measured value (distance) of the arbitrary pixel P2 is d2.

Next, in step S16, as described above, the attachment angle θa and the attachment height da of the TOF sensor 20 are calculated from the following equations (1) and (2) (attachment orientation sensing step).

da=d1cos(θa−θ1) (1)

da=d2cos(θa−θ2) (2)

Next, in step S17, it is determined whether or not the attachment angle θa and the attachment height da of the TOF sensor 20 are within the reference range.

The reference range may be set as desired, according to the user's preference and to the type, shape, performance, and so forth of the TOF sensor 20.

Here, in step S12b, since it was determined in step S17 that the attachment angle θa and the attachment height da are outside of the reference range, the notification unit 17 notifies the user that the measurement result measured by the TOF sensor 20 cannot be corrected.

Next, in step S18, since it was determined in step S17 that the attachment angle θa and the attachment height da are within the reference range, the attachment angle θa and the attachment height da are stored in the memory unit 16.

Next, in step S19, the measurement result of the TOF sensor 20 is corrected on the basis of the values of the attachment angle θa and the attachment height da, and the processing is ended.

After step S19, coordinate transformation may be performed at the time of distance measurement with the TOF sensor 20 using the values for the attachment angle θa and the attachment height da. Alternatively, the user may adjust the attachment orientation of the TOF sensor 20 by referring to the values of the attachment angle θa and the attachment height da.

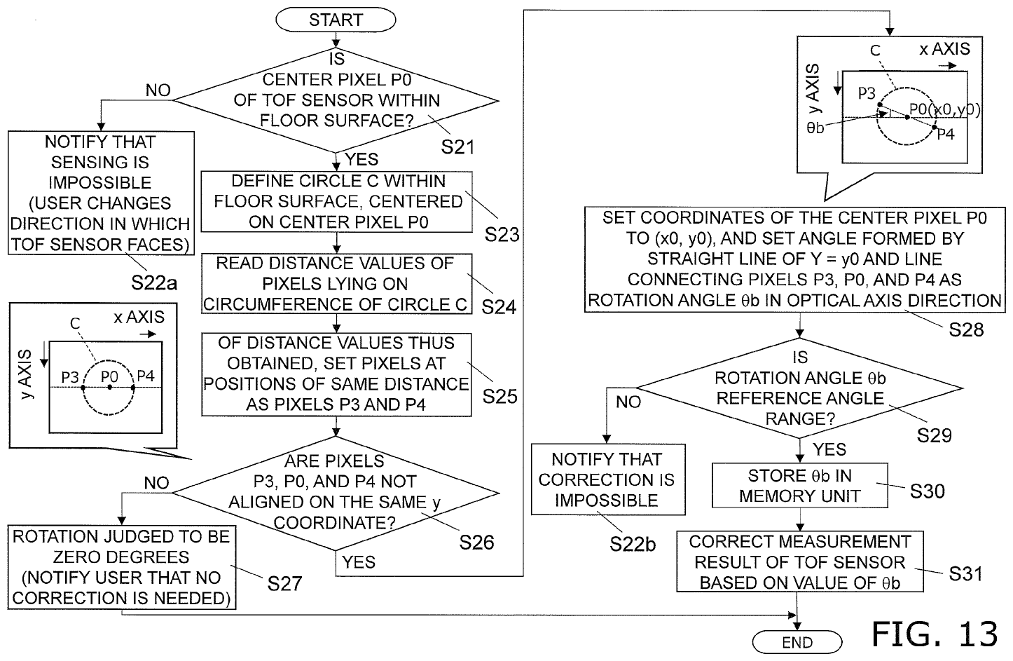

Next, the step of sensing the rotation angle θb as the attachment orientation of the TOF sensor 20 will be described with reference to FIG. 13.

First, as shown in FIG. 13, in step S21, it is determined whether or not the center pixel P0 of the TOF sensor 20 is within the floor surface FL. Here, if the center pixel P0 is within the floor surface FL, the processing proceeds to step S23, but if the center pixel P0 is outside of the floor surface FL, the processing proceeds to step S22a.

Here, in step S22a, since it was determined in step S21 that the center pixel P0 is outside of the floor surface FL, the notification unit 17 notifies the user that information related to the attachment orientation of the TOF sensor 20 cannot be sensed.

Next, in step S23, since it was determined in step S21 that the center pixel P0 is within the floor surface FL, a circle C centered on the center pixel P0 of the TOF sensor 20 is defined as the floor surface FL.

Next, in step S24, the distance values of the pixels lying on the circumference of the circle C are read (distance information acquisition step).

Next, in step S25, of the distance values obtained in step S24, the pixels P3 and P4 at the same distance are used.

Next, in step S26, it is determined whether or not the pixel P3, the center pixel P0, and the pixel P4 are aligned on the same Y coordinate. Here, if the pixel P3, the center pixel P0, and the pixel P4 are not aligned on the same Y coordinate, the processing proceeds to step S28, but if they are aligned, the processing proceeds to step S27.

Next, in step S27, since it was determined in step S26 that the pixel P3, the center pixel P0, and the pixel P4 are aligned on the same Y coordinate, the rotation of the TOF sensor 20 is judged to be zero degrees (there is no deviation in the attachment orientation in the rotation direction), and the processing is ended. At this point, the user may be notified via the notification unit 17 that there is no need for correction due to the rotation of the TOF sensor 20.

Next, in step S28, the coordinates of the center pixel P0 are set to (x0, y0), and the angle formed by the straight line of Y=y0 and the line connecting the pixels P3, P0, and P4 is defined as the rotation angle θb in the optical axis direction (attachment orientation sensing step).

Next, in step S29, it is determined whether or not the rotation angle θb is within the reference angle range, and if it is within the reference angle range, the processing proceeds to step S30, but if it is outside the reference angle range, the processing proceeds to S22b.

Here, in step S22b, since it was determined in step S29 that the rotation angle θb is outside of the reference angle range, the notification unit 17 notifies the user that the measurement result of the TOF sensor 20 cannot be corrected.

Next, in step S30, since it was determined in step S29 that the rotation angle θb is within the reference angle range, the rotation angle θb is stored in the memory unit 16.

Next, in step S31, the result (distance value) measured by the TOF sensor 20 is corrected on the basis of the value of the rotation angle θb, and the processing is ended.

After step S31, coordinate transformation may be performed at the time of distance measurement with the TOF sensor 20 by using the rotation angle θb. Alternatively, the user may adjust the rotation angle of the TOF sensor 20 by referring to the value of the rotation angle θb.

Attachment Orientation Sensing Method upon Return to Dock

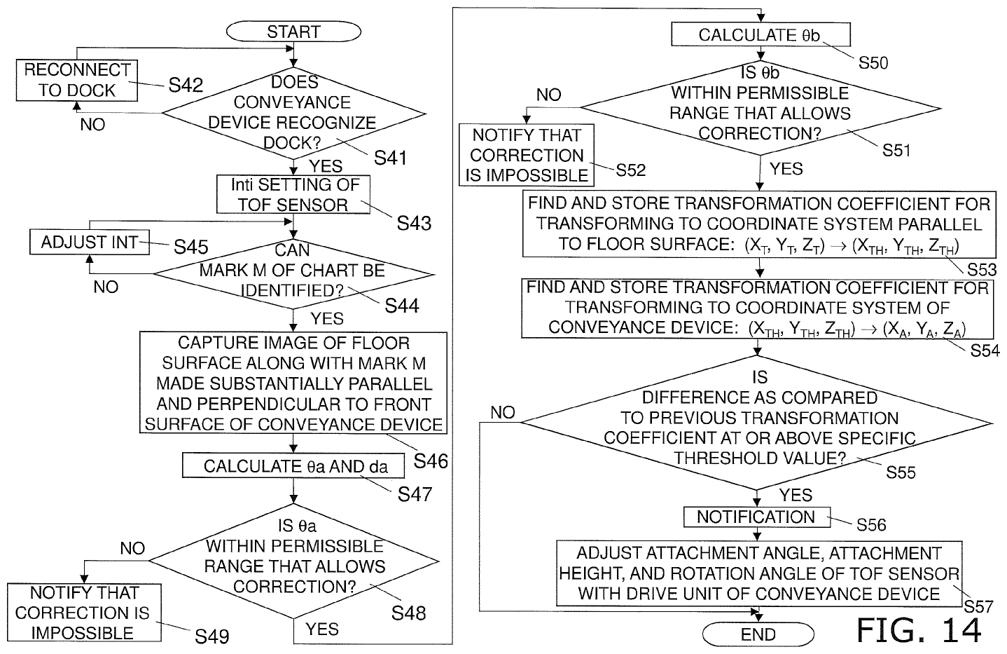

In the method for sensing the attachment orientation of the TOF sensor 20 in this embodiment, the processing performed when the conveyance system 50 returns to the dock 40 will now be described through reference to the flowchart shown in FIG. 14.

Here, the step of adjusting the attachment orientation using the attachment angle θa, the attachment height da, and the rotation angle θb sensed in a state in which the conveyance device 30 to which the TOF sensor 20 is attached has finished a specific job and returned to the dock 40 will be described.

First, as shown in FIG. 14, in step S41, it is determined whether or not the conveyance device 30 is recognized as being connected to the dock 40. Here, if it is recognized that the conveyance device 30 is connected to the dock 40, the processing proceeds to step S43, and if this is not recognized, the processing proceeds to step S42.

Here, in step S42, since it was determined in step S41 that the conveyance device 30 is not recognized as being connected to the dock 40, steps S41 and S42 are repeated until the conveyance device 30 is connected to the dock 40.

Next, in step S43, since it was determined in step S41 that the conveyance device 30 is connected to the dock 40, the initial setting of the exposure time Inti of the imaging element 23 of the TOF sensor 20 is performed.

Next, in step S44, it is determined whether or not the mark M of the chart can be identified by the TOF sensor 20. Here, if the mark M can be identified, the processing proceeds to step S46, and if the mark M cannot be identified, the processing proceeds to step S45.

Next, in step S45, since it was determined in step S44 that the mark M of the chart cannot be identified by the TOF sensor 20, the exposure time Inti of the imaging element 23 of the TOF sensor 20 is adjusted. This adjustment processing for the exposure time Inti is repeated until the mark M on the chart is recognized.

Next, in step S46, since it was determined in step S44 that the mark M of the chart can be identified by the TOF sensor 20, the TOF sensor 20 captures an image of the floor surface FL along with the mark M made substantially parallel to the front surface of the conveyance device 30.

At this point, since the TOF sensor 20 is aligned so that the front surface of the conveyance device 30 is substantially parallel to the line segment L2 of the mark M, the attachment orientation can be sensed more accurately by measuring the distance to the two reference points P1 and P2 on the floor surface FL in this state.

Next, in step S47, the two reference points P1 and P2 are set on the imaged floor surface FL, and the attachment angle θa and the attachment height da of the TOF sensor 20 are calculated from the above equations (1) and (2) (distance information acquisition step, angle information acquisition step, and attachment orientation sensing step).

Next, in step S48, it is determined whether or not the attachment angle θa of the TOF sensor 20 calculated in step S47 is within the reference range. Here, if it is determined that the attachment angle θa is within the reference range, the processing proceeds to step S50, but if it is determined that the attachment angle θa is outside of the reference range, the processing proceeds to step S49.

The reference range may be set as desired, according to the user's preference and the type, shape, performance, and so forth of the TOF sensor 20.

Next, in step S49, since it was determined in step S48 that the attachment angle θa is outside of the reference range, the notification unit 17 notifies the user that the measurement result measured by the TOF sensor 20 cannot be corrected using the attachment angle θa.

Next, in step S50, since it was determined in step S48 that the attachment angle θa is within the reference range, the above-mentioned rotation sensing unit 14c performs calculation processing for the rotation angle θb (attachment orientation sensing step).

Next, in step SM, it is determined whether or not the rotation angle θb is within the correctable reference angle range. If it is within the reference angle range, the processing proceeds to step S53, but if it is outside of the reference angle range, the processing proceeds to S52.

Here, in step S52, since it was determined in step SM that the rotation angle θb is outside of the reference angle range, the notification unit 17 notifies the user that the measurement result of the TOF sensor 20 cannot be corrected using the rotation angle θb.

Next, in step S53, since it was determined in step SM that the rotation angle θb is within the reference angle range, the optical axis coordinate system of the TOF sensor 20 is transformed into a rectangular coordinate system parallel to the floor surface FL.

More specifically, a transformation coefficient for transforming from the TOF optical axis coordinate system (XT, YT, ZT) indicated by the solid lines in FIG. 3 into the three axes (XTH, YTH, ZTH) indicated by the one-dot chain lines in FIG. 3 is found and is stored in the memory unit 16.

Next, in step S54, the rectangular coordinate system parallel to the floor surface FL transformed in step S53 is transformed into the rectangular coordinate system of the conveyance device 30.

More specifically, the transformation coefficient for transforming the three axes (XTH, YTH, ZTH) indicated by the one-dot chain lines in FIG. 3 into the rectangular coordinate system (XA, YA, ZA) of the conveyance device 30 is found and is stored in the memory unit 16.

Next, in step S55, it is determined whether or not the difference as compared to the previous transformation coefficient is at or above a specific threshold value. Here, if the difference from the previous ratio of the transformation coefficient is at or above a specific threshold value, the processing proceeds to step S56, but if it is below the threshold value, it is determined that re-adjustment is unnecessary and the process is ended.

Next, in step S56, since it was determined in step S55 that the difference from the previous ratio of the transformation coefficient is at or above a specific threshold value, the notification unit 17 notifies the user that the attachment orientation of the TOF sensor 20 has significantly deviated from that at the time of the previous adjustment.

Next, in step S57, since it was learned that the attachment orientation of the TOF sensor 20 has significantly deviated from that at the time of the previous adjustment, the attachment angle θa, the attachment height da, and the rotation angle θb of the TOF sensor 20 attached to the conveyance device 30 are adjusted.

### Main Features

The attachment orientation sensing device 10 of this embodiment comprises the distance information acquisition unit 11, the angle information acquisition unit 12, and the attachment orientation sensing unit 14. The distance information acquisition unit 11 acquires information about the distance to reference points P1 and P2 on a floor surface FL according to the phase difference between the received light wave and the emitted light wave emitted from the emission unit 21 included in the TOF sensor 20 toward the floor surface FL. The angle information acquisition unit 12 acquires information about the angle to the reference points P1 and P2. The attachment orientation sensing unit 14 senses the attachment orientation of the TOF sensor 20 with respect to the floor surface FL on the basis of the distance information and the angle information acquired by the distance information acquisition unit 11 and the angle information acquisition unit 12.

Consequently, the attachment orientation of the TOF sensor 20 with respect to the floor surface FL or other such reference surface can be automatically sensed by using the results (distance information and angle information) measured by the TOF sensor 20.

This means that the attachment orientation of a TOF sensor 20 attached to any of various devices can be sensed without having to perform measurement using an orientation sensing device such as an inclination sensor or a level, and the measurement results of the TOF sensor 20 can be corrected as needed whenever the attachment orientation is disturbed.

### Other Embodiments

An embodiment of the present invention was described above, but the present invention is not limited to or by the above embodiment, and various modifications are possible without departing from the gist of the invention.

(A)

In the above embodiment, an example was given in which the present invention was realized as an attachment orientation sensing device and an attachment orientation sensing method, but the present invention is not limited to this.

For example, the present invention may instead be realized as attachment orientation sensing program that causes a computer to execute the above-mentioned attachment orientation sensing method with a distance measurement device.

This program is stored in a memory (memory unit) installed in the distance measurement device, and the CPU reads the attachment orientation sensing program stored in the memory and causes the hardware to execute various steps. More specifically, the same effect as described above can be obtained by having a CPU read the program and execute the above-mentioned distance information acquisition step, angle information acquisition step, and attachment orientation sensing step.

Also, the present invention may be realized as a recording medium on which the attachment orientation sensing program is stored.

(B)

In the above embodiment, an example an example was given in which the TOF sensor 20 (distance measurement device) was attached to the conveyance device 30, but the present invention is not limited to this.

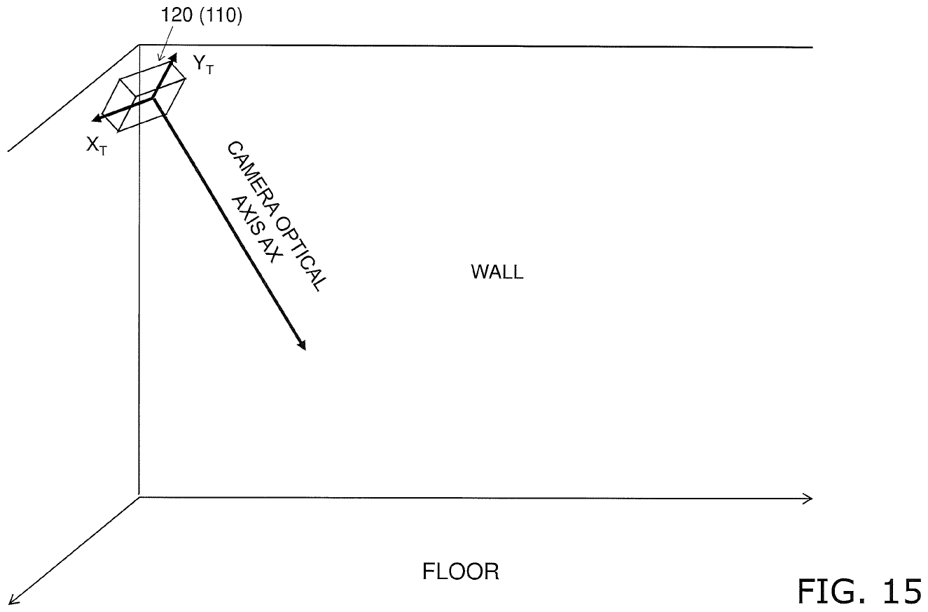

For example, the configuration may be such that the distance measurement device 120 (attachment orientation sensing device 110) is provided inside a surveillance camera or the like, or to a monitoring device mounted on a wall surface in a room, as shown in FIG. 15, instead of the conveyance device.

In this case, the attachment orientation of a monitoring device can be automatically sensed by disposing the device facing toward the camera optical axis AX with respect to the floor surface, so that the floor surface will serve as the reference surface.

Also, the attachment orientation sensing device of the present invention may be attached to another device, such as an automobile, a motorcycle, an electric bicycle, or another such vehicle.

(C)

In the above embodiment, an example was given in which the attachment orientation sensing device 10 was provided inside the TOF sensor 20, but the present invention is not limited to this.

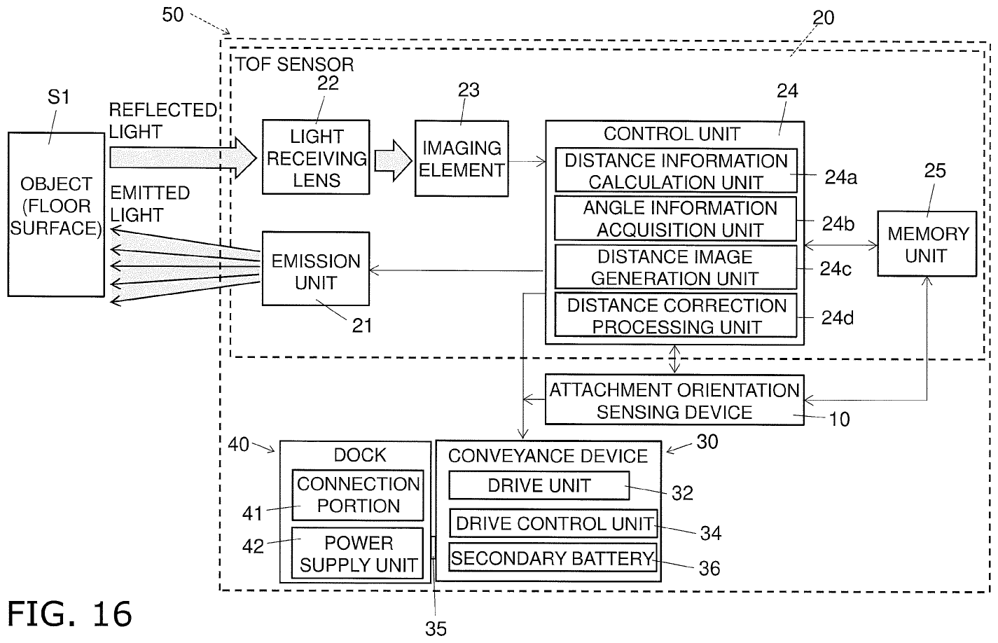

For example, the attachment orientation sensing device 10 may be configured to be provided outside the TOF sensor 20, as shown in FIG. 16.

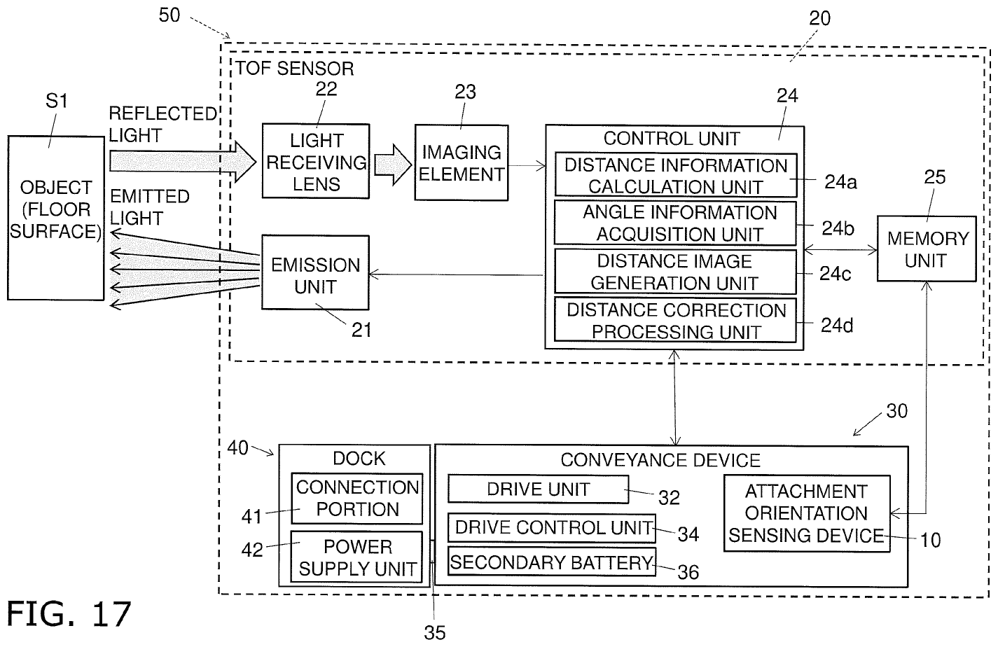

Alternatively, as shown in FIG. 17, the attachment orientation sensing device 10 may be configured to be provided inside the conveyance device 30 to which a distance measurement device such as a TOF sensor is attached.

(D)

In the above embodiment, an example was given in which the attachment angle, the attachment height, and the rotation angle with respect to the floor surface FL were sensed as the attachment orientation of the TOF sensor 20, but the present invention is not limited to this.

For example, some other attachment orientation, such as twisting, may be sensed instead of the above-mentioned attachment angle.

(E)

In the above embodiment, an example was given in which the attachment angle, the attachment height, etc., of the TOF sensor 20 were sensed by using information about the distance from the TOF sensor 20 to two points on the floor surface FL, but the present invention is not limited to this.

For example, the attachment angle, the attachment height, etc., may be sensed by using the distance to three or more points on a reference surface such as a floor surface.

(F)

In the above embodiment, an example was given in which the floor surface FL was used as the reference surface for automatically sensing the attachment orientation of the TOF sensor 20, but the present invention is not limited to this.

For example, a wall surface, a ceiling surface, or other such surface may be used instead of a floor surface as the reference surface.

(G)

In the above embodiment, an example was given in which the attachment orientation of the TOF sensor 20 was sensed by using the position where the dock 40 is installed as a specific sensing position, but the present invention is not limited to this.

For example, if the floor surface or other such reference surface does not have any inclination, etc., there will be no need to sense the attachment orientation at a specific position, and the attachment orientation may be sensed at the desired position and timing.

(H)

In the above embodiment, an example was given in which the TOF sensor 20 was used as a distance measurement device, but the present invention is not limited to this.

For example, instead of a TOF sensor, some other distance measurement device that can acquire information about the distance to a reference point, and that has information about the angle to the reference point, such as LiDAR (light detection and ranging) or an SC (structural camera), may be used.

### INDUSTRIAL APPLICABILITY

The distance measurement device of the present invention has the effect of allowing the attachment orientation of a distance measurement device attached to any of various devices to be sensed without having to use a device for orientation sensing, such as an inclination sensor or a level, and therefore can be widely applied to various devices in which a distance measurement device can be installed.

### REFERENCE SIGNS LIST

10 attachment orientation sensing device
11 distance information acquisition unit
12 angle information acquisition unit
13 distance image acquisition unit
14 attachment orientation sensing unit
14a attachment angle sensing unit
14b attachment height sensing unit
14c rotation sensing unit
15 correction availability determination unit
16 memory unit
17 notification unit
20 TOF sensor (distance measurement device)
21 emission unit
22 light receiving lens
23 imaging element (sensing unit)
24 control unit
24a distance information calculation unit
24b angle information acquisition unit
24c distance image generation unit
24d distance correction processing unit
25 memory unit
30 conveyance device (specific thing)
31 main body unit
32 drive unit
32a wheel
33 forks
34 drive control unit
35 charging terminal
36 secondary battery
40 dock (specific sensing position)
41 connection portion
42 power supply unit
50 conveyance system (distance measurement system)
110 attachment orientation sensing device
120 TOF sensor (distance measurement device)
AX optical axis
C circle
d, d1, d2 distance
da height (distance)
FL floor surface (reference surface)
L1 light
L2 line segment
P0 image center (pixel)
P1, P2 reference point
P3, P4 pixel
S1 object
θ1, θ2 angle information
θ an attachment angle
θb rotation angle

1. An attachment orientation sensing device that senses an attachment orientation of a distance measurement device mounted on a specific thing, the attachment orientation sensing device comprising:
a distance information acquisition unit configured to acquire distance information about a distance to a reference point on a reference surface according to a phase difference between a received light wave and an emitted light wave emitted from an emission unit included in the distance measurement onto the reference surface;
an angle information acquisition unit configured to acquire angle information about the angle to the reference point; and
an attachment orientation sensing unit configured to sense an attachment orientation of the distance measurement device with respect to the reference surface on the basis of the distance information and the angle information acquired by the distance information acquisition unit and the angle information acquisition unit.

2. The attachment orientation sensing device according to claim 1,
wherein the attachment orientation sensing unit senses at least one of an inclination angle of the distance measurement device with respect to the reference surface, the distance from the reference surface, and a rotation angle with respect to the reference surface, as the attachment orientation.

3. The attachment orientation sensing device according to claim 1,
wherein the attachment orientation sensing unit senses the attachment orientation by using information about the distance and the angle to two reference points on the reference surface.

4. The attachment orientation sensing device according to claim 1,
wherein the distance measurement device further includes a distance image generation unit that generates a distance image including the reference surface, on the basis of an acquisition results of the distance information acquisition unit and the angle information acquisition unit, and
further comprising a distance image acquisition unit that acquires the distance image from the distance image generation unit.

5. The attachment orientation sensing device according to claim 4,
wherein the attachment orientation sensing unit senses the attachment orientation of the distance measurement device by using a first distance to a first reference point on the reference surface at a first pixel included in the distance image acquired by the distance image acquisition unit, and a first angle with respect to the reference surface, as well as a second distance to a second reference point on the reference surface at a second pixel that is different from the first pixel, and a second angle with respect to the reference surface.

6. The attachment orientation sensing device according to claim 4,
wherein the attachment orientation sensing unit senses rotation with respect to the reference surface as the attachment orientation of the distance measurement device by using a first angle with respect to an emission axis of a light emitted from the emission unit at a first pixel included in the distance image acquired by the distance image acquisition unit, and a second angle with respect to the emission axis of the light emitted from the emission unit at a second pixel that is different from the first pixel.

7. The attachment orientation sensing device according to claim 4,
wherein the attachment orientation sensing unit senses rotation of the attachment orientation of the distance measurement device on the basis of whether or not the positions of pixels at the same distance to the reference surface in the distance image acquired by the distance image acquisition unit are moving from a specific reference position.

8. The attachment orientation sensing device according to claim 4,
wherein the attachment orientation sensing unit senses a rotation angle of the attachment orientation of the distance measurement device on the basis of how many degrees the positions of pixels at the same distance to the reference surface in the distance image acquired by the distance image acquisition unit have rotated from a specific reference position.

9. The attachment orientation sensing device according to claim 1,
further comprising a correction possibility determination unit configured to determine whether or not to correct a measurement result in the distance measurement device on the basis of a sensing result in the attachment orientation sensing unit.

10. The attachment orientation sensing device according to claim 1,
wherein the distance information acquisition unit acquires the distance information and the angle information with respect to the reference point acquired at a specific sensing position.

11. The attachment orientation sensing device according to claim 10,
wherein the attachment orientation sensing unit senses the attachment orientation by using the distance information and the angle information with respect to the reference surface acquired at the specific sensing position.

12. The attachment orientation sensing device according to claim 1,
further comprising a memory unit configured to store information related to the attachment orientation of the distance measurement device sensed by the attachment orientation sensing unit.

13. The attachment orientation sensing device according to claim 1,
wherein the reference surface is a floor surface.

14. The attachment orientation sensing device according to claim 1,
wherein the distance measurement device is any one of a TOF (time-of-flight) sensor, a LiDAR (light detection and ranging), or an SC (structural camera).

15. An attachment orientation sensing method for sensing an attachment orientation of a distance measurement device mounted on a specific thing, the method comprising:
a distance information acquisition step of acquiring from the distance measurement device distance information about the distance to a reference point on a reference surface according to a phase difference between a received light wave and an emitted light wave of light emitted from an emission unit included in the distance measurement device toward the reference surface;
an angle information acquisition step of acquiring angle information about the angle to the reference point from the distance measurement device; and
an attachment orientation sensing step of sensing the attachment orientation of the distance measurement device with respect to the reference surface on the basis of the distance information and the angle information acquired in the distance information acquisition step and the angle information acquisition step.

16. An attachment orientation sensing program for sensing an attachment orientation of a distance measurement device mounted on a specific thing, the program causing a computer to execute an attachment orientation sensing method comprising:
a distance information acquisition step of acquiring from the distance measurement device distance information about the distance to a reference point on a reference surface according to a phase difference between a received light wave and an emitted light wave of light emitted from an emission unit included in the distance measurement device toward the reference surface;
an angle information acquisition step of acquiring angle information about the angle to the reference point from the distance measurement device; and
an attachment orientation sensing step of sensing the attachment orientation of the distance measurement device with respect to the reference surface on the basis of the distance information and the angle information acquired in the distance information acquisition step and the angle information acquisition step.
